(19) United States
(12) Patent Application Publication
(10) Pub. No.: US 2017/0139380 A1
(43) Pub. Date: May 18, 2017

(54) CLOUD-BASED CULTIVATION SYSTEM FOR PLANTS

(71) Applicant: ATP-labs Ltd., Tel Aviv (IL)

(72) Inventors: Ilay Englard, Tel Aviv (IL); Niv Noach, Tel Aviv (IL)

(21) Appl. No.: 15/221,670

(22) Filed: Jul. 28, 2016

Related U.S. Application Data
(60) Provisional application No. 62/197,611, filed on Jul. 28, 2015.

(51) Int. Cl. G05B 13/02; A01G 1/00; A01G 25/16; A01C 21/00; A01G 31/00; A01G 17/00; A01G 9/20; G06Q 10/06; A01G 9/00

(52) U.S. Cl. CPC G05B 13/024; G06Q 10/0631; A01G 1/001; A01G 25/165; A01G 25/167; A01G 9/00; A01G 31/00; A01G 17/005; A01G 9/20; A01C 21/007

(57) ABSTRACT

A system for managing cultivation of plants includes a database storing information about a plurality of growing beds and a multiplicity of farming agents. Each agent is associated with one growing bed and runs a cultivation program on inputs from a farmer of said associated growing bed and information about said associated growing bed from said database. Each agent enforces user preferences and business rules for said associated growing bed and provides cultivation instructions to said farmer to cultivate its associated growing bed.

### CROSS REFERENCE TO RELATED APPLICATIONS

This application claims priority from U.S. provisional patent application 62/197,611, filed 28 Jul. 2015, which is incorporated herein by reference.

### FIELD OF THE INVENTION

The present invention relates to agriculture generally and to a cultivation system for agriculture in particular.

### BACKGROUND OF THE INVENTION

Agriculture has been around for millennia. Ideally, farmers want to grow their plants in the most optimal way, to ensure maximum yields and there have been many methods and machines designed for this purpose over the years. For example, there are controlled irrigation systems, as well as irrigation systems which also provide fertilization (known as “fertigation” systems).

Some systems utilize a “smart irrigation system” which can be triggered by a timer or by a remote system that decides how to irrigate based on the weather forecast and/or on moisture sensor readings.

### SUMMARY OF THE PRESENT INVENTION

There is therefore provided, in accordance with a preferred embodiment of the present invention, a system for managing cultivation of plants. The system includes a database storing information about a plurality of growing beds and a multiplicity of farming agents. Each farming agent is associated with one growing bed and runs a cultivation program on inputs from a farmer of the associated growing bed and information about the associated growing bed from the database. Each farming agent enforces user preferences and business rules for the associated growing bed and provides cultivation instructions to the farmer to cultivate its associated growing bed.

Moreover, in accordance with a preferred embodiment of the present invention, the system also includes input from a community of growers and/or from external sources. It may also include at least one sensor to measure an attribute of at least one growing bed having the plants and at least one actuator to provide an input to the at least one growing bed. The at least one sensor senses pH, soil moisture, light, temperature, electrical conductivity, nutrients or an image of the bed. The at least one actuator is an illumination element, a nutrient provider, a watering system, an irrigation valve, an irrigation pump or a fertilizing element.

Further, in accordance with a preferred embodiment of the present invention, the database includes a crop knowledge index to store cultivation parameters as a function of crop variety and cultivation method.

Still further, in accordance with a preferred embodiment of the present invention, the instructions to the farmer include at least one of: harvesting, manual irrigation, manual fertilizing, pest control, disease control, scouting, weeding, testing and pruning of the plants in the bed.

Additionally, in accordance with a preferred embodiment of the present invention, the system also includes a yield optimizer to compare ideal plant data to historical data on the plants to generate personalized cultivation recommendations to the farmer.

Moreover, in accordance with a preferred embodiment of the present invention, the system also includes a plant health analyzer to estimate health of the at least one plant by capturing feedback at least from the farmer and by comparing the feedback to information on plant growth in similar environment.

Further, in accordance with a preferred embodiment of the present invention, the system also includes a wireless sensor network to connect the at least one sensor and the at least one actuator together and to communicate with a hub. The hub may communicate with the multiplicity of farming agents via a data network. Alternatively, in accordance with a preferred embodiment of the present invention, the hub is mounted on an aerial device.

Moreover, in accordance with a preferred embodiment of the present invention, the system also includes an agent evaluation engine to activate an associated farming agent upon receipt at least of measurements from an associated sensor.

Further, in accordance with a preferred embodiment of the present invention, the system also includes a growing recipe database to store farming agent growing recipes produced by a multiplicity of farmers, in accordance with a preferred embodiment of the present invention, a growing recipe rating unit to store ratings for the farming agent growing recipes and a marketplace to enable the multiplicity of farmers to share resources for their growing beds.

Still further, in accordance with a preferred embodiment of the present invention, the at least one bed is at least a portion of: an indoor garden, an outdoor garden, a vertical garden, a hydroponic garden, an aquaponics garden, a field, an orchard and a farm.

Moreover, in accordance with a preferred embodiment of the present invention, the external sources are one of: a weather forecast and a crop infestation forecast.

There is also provided, in accordance with a preferred embodiment of the present invention, a system for managing cultivation of plants. The system includes a cultivation program to perform complex logic on inputs at least from one sensor and from a farmer about an associated growing bed and from external data at least about the region of the associated growing bed and to provide cultivation instructions to at least one actuator and to the farmer to cultivate the associated growing bed.

There is also provided, in accordance with a preferred embodiment of the present invention, a method for managing cultivation of plants. The method includes storing information about a plurality of growing beds in a database and running a cultivation program on inputs from a farmer of the associated growing bed and information about the associated growing bed from the database. The cultivation program enforces user preferences and business rules for the associated growing bed and provides cultivation instructions to the farmer to cultivate its associated growing bed.

Moreover, in accordance with a preferred embodiment of the present invention, the method also includes receiving input from a community of growers and/or from external sources.

Further, in accordance with a preferred embodiment of the present invention, the method also includes measuring an attribute of at least one growing bed having the plants and providing an input to the at least one growing bed.

Still further, in accordance with a preferred embodiment of the present invention, the method also includes storing cultivation parameters as a function of crop variety and cultivation method in the database.

Moreover, in accordance with a preferred embodiment of the present invention, the method also includes comparing ideal plant data to historical data on the plants to generate personalized cultivation recommendations to the farmer.

Additionally, in accordance with a preferred embodiment of the present invention, the method also includes estimating health of the at least one plant by capturing feedback at least from the farmer and by comparing the feedback to information on plant growth in similar environments.

Further, in accordance with a preferred embodiment of the present invention, the method also includes connecting the at least one sensor and the at least one actuator together and communicating with a hub. Additionally, in accordance with a preferred embodiment of the present invention, the method includes mounting the hub on an aerial device.

Further, in accordance with a preferred embodiment of the present invention, the method also includes communicating with the multiplicity of farming agents via a data network.

Still further, in accordance with a preferred embodiment of the present invention, the method also includes activating the running upon receipt at least of measurements from an associated sensor.

Finally, in accordance with a preferred embodiment of the present invention, the method also includes at least one of: storing growing recipes produced by a multiplicity of farmers, storing ratings for the growing recipes and enabling the multiplicity of farmers to share resources for their growing beds.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a cultivation system, constructed and operative in accordance with a preferred embodiment of the present invention;

FIG. 2 is a schematic illustration of a farming agent, useful in the cultivation system of FIG. 1;

FIG. 3 is a detailed schematic illustration of the operation of an agent evaluation engine, forming part of the cultivation system of FIG. 1;

FIGS. 4A and 4B are schematic illustrations of code for two exemplary farming agents;

FIG. 5 is a schematic illustration of a farming agent operation, useful in understanding the cultivation system of FIG. 1; and

FIG. 6 is a schematic illustration of a growing recipe system, forming part of the cultivation system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that there is no platform that provides automated data driven plant cultivation decisions and/or crop yield optimization based on continuous data from a variety of sensing devices and from a community of growers. Existing systems that control and automate plant growth are based only on a limited number of measurements and inputs. Moreover, Applicants have realized that most horticulture knowledge is opaque and difficult to access and share between people. Accordingly, the present invention is a cultivation system for gardens and farms of any size, resulting in data-driven agriculture and farm automation. After system setup, the system constantly receives measurement signals from a range of sensing applies computation models that are hosted in the system and provides actions upon the result of the computations. This is a cyclic process that “operates” plant growth. The cultivation system may sit on top of different kinds of equipment for agriculture, such as sensors, irrigation controllers, machinery, etc.

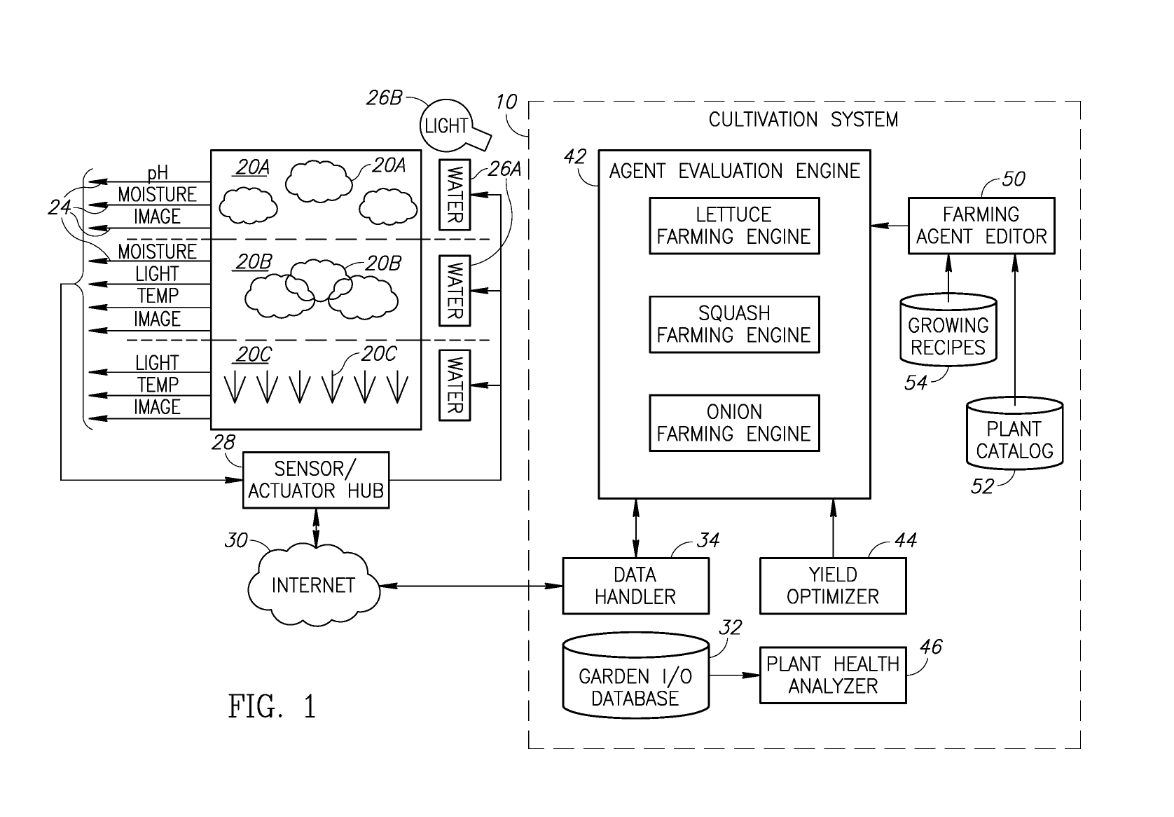

Reference is now made to FIG. 1, which schematically illustrates a cultivation system 10 for plantations, crops and/or farms, constructed and operative in accordance with a preferred embodiment of the present invention, operating a growing field or bed 20. Growing bed 20 may be a field, garden, bed of any size or shape, or portion thereof and may have growing therein one type of plant 22. As an example, FIG. 1 shows lettuce 22A, squash 22B and onions 22C growing in growing beds 20A, 20B and 20C, respectively. It will be appreciated that this is an example only; a typical growing bed 20 may have other types of plants, such as flowers, trees, fruit, bushes, etc.

In accordance with a preferred embodiment of the present invention, cultivation system 10 may operate with a multiplicity of sensors 24 that measure the environment in and around garden bed 20. For example and as shown in FIG. 1, the sensors may sense pH, soil moisture, light, temperature, electrical conductivity, nutrient readings, etc., and as shown, there may be different sensors per bed, which may depend on the crop or plant growing in the bed 20. The sensors may also include a camera to take periodic images of bed 20. Cultivation system 10 may also operate with a multiplicity of actuators 26 that may affect the environment in and around each garden bed 20, typically in order to cultivate the plants in the bed. Exemplary actuators 26 may include a watering system 26A and an illumination system 26B. Other actuators may include irrigation valves, pumps, fertilizing elements etc. Cultivation system 10 may also ‘activate’ the farmer who owns or works on the bed to take cultivation actions, such as weeding, harvesting, manual irrigation, manual fertilizing, pest control, disease control, scouting, weeding, testing and pruning, typically via notifications, discussed in more detail hereinbelow.

In accordance with a preferred embodiment of the present invention, sensors 24 and actuators 26 may be connected together to a sensor/actuator hub 28, which may act as a gateway between sensors 24 and actuators 26 and cultivation system 10. Sensors 24 and actuators 26 may be connected to hub 28 in any suitable manner, such as in a wired or wireless manner and each individually or through any suitable network, such as a mesh network. In the latter example, each sensor 24 and actuator 26 may comprise a network module to network to the other sensors and to hub 28. The network modules may enable dozens to hundreds of sensors to communicate without any cellular/WiFi coverage. Each sensor 24 and actuator 28 may comprise its own power source, particularly if it is a wireless device.

Hub 28 may communicate with cultivation system 10 via the Internet 30, or via any other suitable data communication network. Hub 28 may pass the data to and from cultivation system 10 as is, or may first process the signals, at least to improve their signal/noise ratio. Each hub 28 may handle a predefined number of devices and/or a predefined area and, as a result, may handle multiple beds or only a section of a very large bed.

In accordance with a preferred embodiment of the present invention, cultivation system 10 may comprise a garden I/O database 32 to store sensor and actuator data received via hub 28 from many beds 20, as well as information about each growing bed 20, its controlling devices, the plants which grow on it and other bed attributes, such as location, soil type, micro-climate, height etc. Cultivation system 10 may also comprise a plurality of farming agents 40, one per each section of bed 20 and/or per each type of plant in bed 20, which may review the sensor data from its section of its bed 20 and may determine what cultivation activities, such as watering, lighting, fertilizing, weeding, etc., have to happen on its section of bed 20 at every given time in order to achieve specific plant characteristics. FIG. 1 shows a lettuce farming agent 40A, a squash farming agent 40B and an onion farming agent 40C.

Cultivation system 10 may comprise an agent evaluation engine 42 to operate farming agents 40, a data handler 41 to process the information to and from agent evaluation engine 42, a yield optimizer 44 to review the information in garden I/O database 32 and to instruct the relevant farming agents 40 to change their operation in order to improve yields and a plant health analyzer 46 which may also review the information in garden I/O database 32, and particularly to review the images stored therein, to determine the health of a particular section of a bed 20 controlled by a farming agent 40 and to instruct the relevant farming agent 40 for the section if necessary to change its operation in order to improve the health of the plants therein. Plant health analyzer 46 may also utilize user input, such as uploaded images, Boolean feedback (such as ok/not ok), notifications about which cultivation actions were performed by the farmer, etc. to analyze the health of the plants.

Cultivation system 10 may also comprise a farming agent editor 50, a plant catalog 52 and a growing recipes database 54. Farming agent editor 50 may include a bed editor to define which sensors 24 and actuators 26 cover each bed 20 and which plant 22 grows in bed 20, and a farming agent editor 50 to enable the farmer to create the relevant farming agent 40 for bed 20. Each farming agent 40 may define the way bed 20 is to be operated as a function of the real-time inputs from sensors 24 and using actuators 26. Each agent 40 may take into account multiple data signals, optimal plant needs, sensor readings, user constraints, and external web data, such as weather forecast, cultivation protocols etc.

Farming agent editor 50 may define a set of language primitives, as follows:
a. Plant: a specie, its attributes and its optimal growing conditions;
b. Sensor: an abstraction of any device which generates information about the plant growing environment and sends signals;
c. Actuator: an abstraction of any device that can affect the plant's growing conditions;
d. Bed is an object in the system that includes:
   i. A list of plants
   ii. A set of sensors
   iii. A set of actuators
e. Agent is a cultivation logic which operates in the context of a bed, receiving input signals and a previous state and outputting a set instructions and insights; and
f. Recipe is a set of agents which optimize per plant utility function.

A farmer may utilize the language primitives when defining his/her garden or field and when creating his/her farming agents 40. S/he may define an unlimited number of growing beds, sections of beds, agents, irrigation zones, etc.

Plant catalog 52 may comprise a database of known plants and their attributes and growing recipes database 54 may comprise sample farming agents 40 for different types of plants which a user may utilize to create his/her own farming agents 40.

To utilize cultivation system 10, each farmer, or other kind of user, may deploy sensors 24 and actuators 26 in and around garden bed 20: The farmer may then utilize farming agent editor 50 to configure the bed and may define the following information about the bed:
a. Enrolls sensors 24 and actuators 26 by listing their device identification (deviceID) and other characteristics;
b. Defines beds 20 and lists therein:
   i. the sizes of the beds 20;
   ii. the growth medium (soil, water) and the specific type of medium;
   iii. which devices 24/26 are attached to which bed 20 and, possibly their GPS location, which reflects how they're physically deployed;
   iv. which plants grow on which bed 20;

After configuring the bed, the farmer may create a farming agent 40 per bed 20 to read inputs from its associated sensors 24 and trigger actions by its associated actuators 26 or by farming agent 40. An example of the latter may be:
i. Change actuator mode; or
ii. Send a notification to the user interface for the farmer to take an action.

The farmer may define his or her own recipes for growing plants, based on his experience, or he may utilize other growing recipes, previously defined by other farmers or other users and stored in garden database 32. The recipes may define the algorithm that handles the incoming events and that generates insights, actions and intermediate data to be stored in database 32.

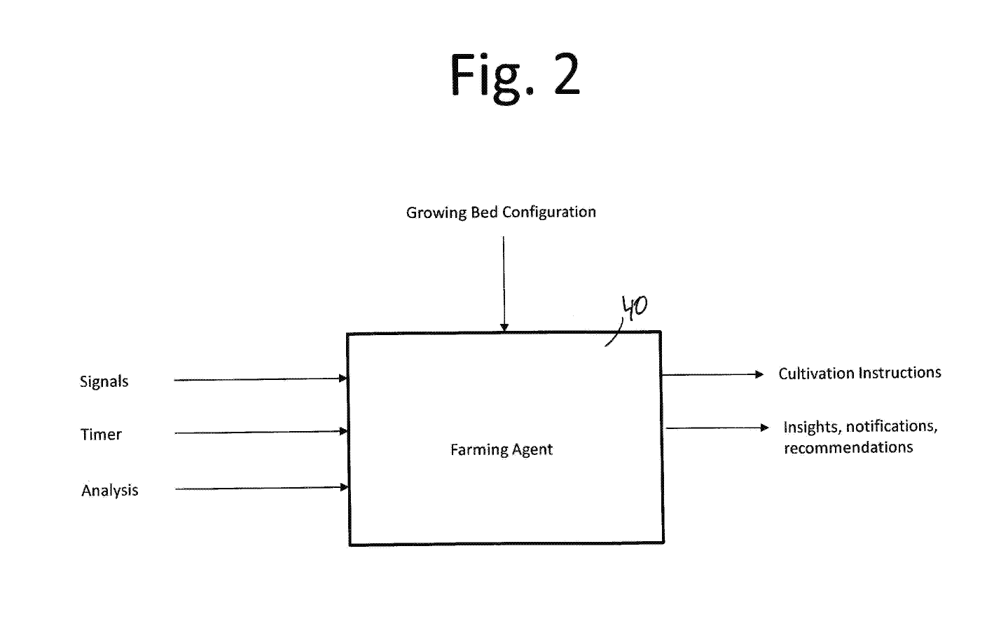

As can be seen in FIG. 2, to which reference is now briefly made, each farming agent 40 may utilize a growing bed configuration and may receive measurement signals and timer signals, as well as analysis information, as input. Farming agents 40 may operate on the input data and may generate therefrom cultivation instructions (i.e. activation of actuators 26) and insights, notifications and recommendations to the farmer. Specifically, agent evaluation engine 42 may gather measurement readings on a periodic or irregular basis from sensors 24 and may activate their associated farming agent(s) 40 upon receipt or when desired. In addition, agent evaluation engine 42 may be triggered by timers, which ensure that, if no data has been received for a particular agent 40 within a time specified therein, the agent 40 runs nonetheless and takes any necessary actions as a result. Each farming agent 40 may be event driven such that, when an event (a reading or a timer activation) arrives, the agent 40 checks determines, according to its recipes or algorithms, how to respond and whether or not it needs to trigger something or to provide a notification to the farmer, generally to perform a farming action on the bed.

In addition, the farmer may provide feedback, typically through a feedback user interface forming part of plant health analyzer 46, on each plant and its attributes (e.g. he may push a “like” button when the plant looks healthy or an “insect” button when the plant shows signs of infestation, etc.). Plant health analyzer 46 may regularly review this data and the sensor and actuator data stored in database 32 to provide insight on how to improve the health of the plants, which may be provided to the relevant farming agents (whether for a particular agent or for a group of agents for the same type of plant, area, etc.).

Similarly, yield optimizer 44 may regularly review the data stored in database 32, typically for multiple beds in a particular area, to compute insights and cultivation instructions to improve yield which may also be provided to the relevant farming agents.

At any time, the farmer may access cultivation system 10 remotely to review live information on the status of the plants, their expected growth cycles, and any relevant recommendations.

It will be appreciated that cultivation system 10 may be utilized to do research on agriculture. For example, a research farmer may plant a plurality of different beds of identical plants and may define different farming agents and schedules for the different beds.

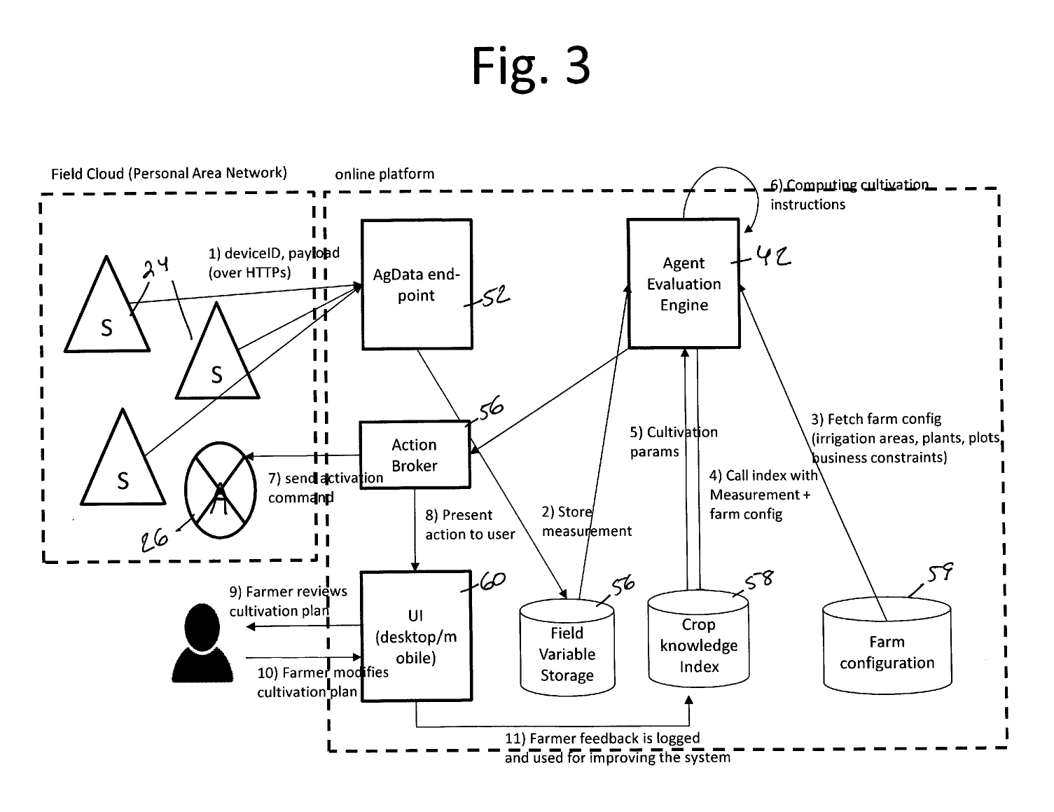

Reference is now made to FIG. 3, which details the operating aspect of cultivation system 10. Similar reference numerals refer to similar elements. FIG. 3 shows the devices (sensors 24 and actuators 26) in a farmer's field or bed 20, connected together in a “field cloud” 50 and communicating with an agdata (agricultural data) endpoint 52 and an action broker 54 forming part of data handler 41. Agdata endpoint 52 may handle sensor data while action broker 54 may transmit activation commands to actuators 26. In addition, agdata endpoint 52 may store the received measurement data in a field variable storage portion 56 of garden I/O database 32. Database 32 may also have a crop knowledge index 58, which may store cultivation parameters as a function of crop variety and cultivation method and a farm configuration storage section 59, which may store the irrigation areas, plants, plots (beds) and business constraints of each farm and bed. Finally, cultivation system 10 comprises a user interface 60 with which action broker 56 may update the farmer on actions taken on the field or bed 20 as well as may provide notifications from the farming agents 40 he has defined, where the notifications may be notices or instructions to perform a cultivation action, such as harvesting, weeding or trimming the plant. User interface 60 may be implemented on a desktop and/or a mobile device.

Initially (step 1), sensors 20 may transmit their measurement signals to agdata endpoint 52, listing their deviceID and providing their measurement payload. Other information which may be included in the data packet may be a time stamp, a message ID and a hub ID. In accordance with a preferred embodiment of the present invention, this data may be transmitted using a proprietary protocol or, if the sensors 24 are wireless network devices, the data may be transmitted as an HTTP request .Agdata endpoint 52 may process the measurement and may store it, in step 2, in field variable storage 56, along with any other relevant information, such as location of the sensor. Field variable storage 56 may also provide the measurement to agent evaluation engine 42 for processing. Agent evaluation engine 42 may check the deviceID and may fetch, in step 3, the bed configuration associated with the deviceID of the sensor sending the measurement from farm configuration section 59 of database 32.

In step 4, agent evaluation engine 42 may access crop knowledge index 58 with the historical measurement data and the farm configuration and may receive (step 5) cultivation parameters for the given measurement and farm configuration. With this information, agent evaluation engine 42 may run (step 6) the farming agent associated with the deviceID of the sensor 24 sending the measurement and may instruct action broker 56 to take an appropriate action. In step 7, action broker 56 may transmit an activation command to actuator(s) 26 and/or may present (step 8) the action to be performed to the farmer via user interface 60. The farmer may review (step 9) the cultivation plan and may, if desired, modify (step 10) the action. If so, user interface 60 may provide the farmer's feedback to crop knowledge index 58, associated with the types of crops associated with the deviceID of the sensor.

Agent evaluation engine 42 may be implemented in any desired way. It may perform the following actions: process all incoming signals; run multiple algorithms on a single bed 20 and/or run the same algorithm on multiple beds 20, quickly fetch/store plant-bed state, produce instructions for actuators 26 in each bed 20, and have an internal timer event to wake-up farming agents 40 according to the timing described therein. In addition, it may act to maintain a small foot-print of data for each bed 20 and may have a simple API.

For example, agent evaluation engine 42 may have a C# simple class implementation for each agent 40 and may implement each agent with the following actions:
a. declare all required sensors/activators as properties;
b. implement the ‘void Setup(User, SetupUtils)’ method to declare general setup parameters of the agent (scheduling, requirements and override defaults); and
c. Implement the ‘State Process Measurements (IEnumerable <Measurements>, User, Utils, State current)’ method to process events and update the state of the associated bed 20.

In accordance with a preferred embodiment of the present invention, farming agent editor 50 may provide a platform for generating farming agents and may host farming agents 40 written by third parties. These may be the “growing recipes” stored in growing recipes database 54.

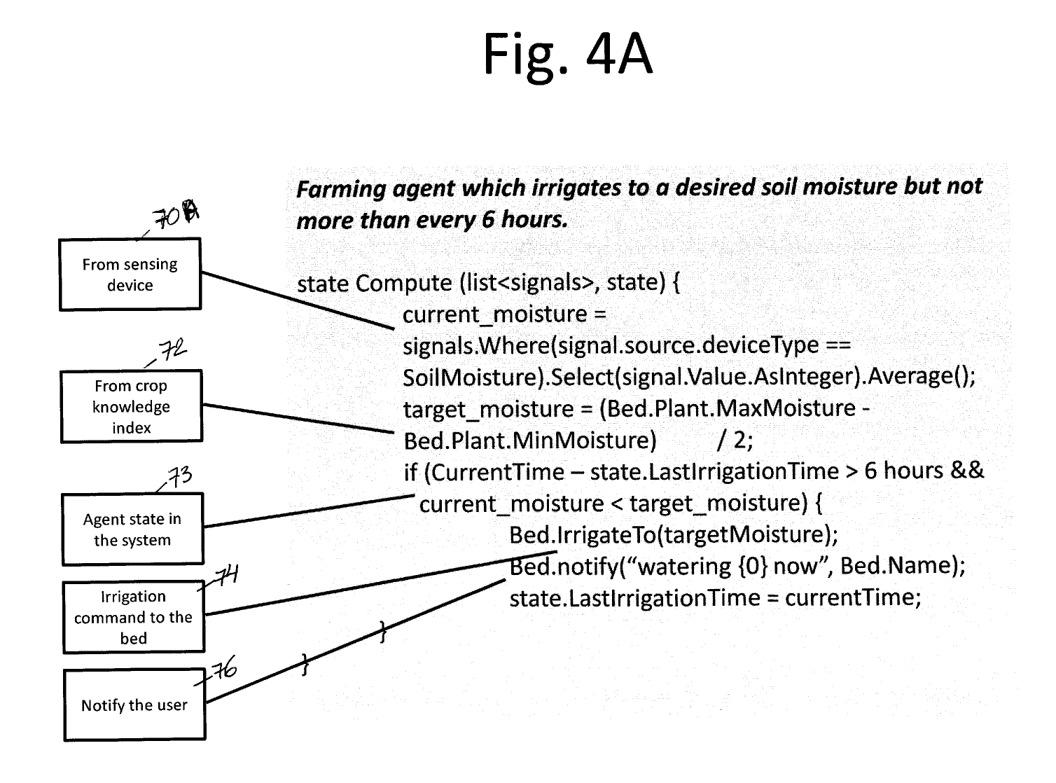

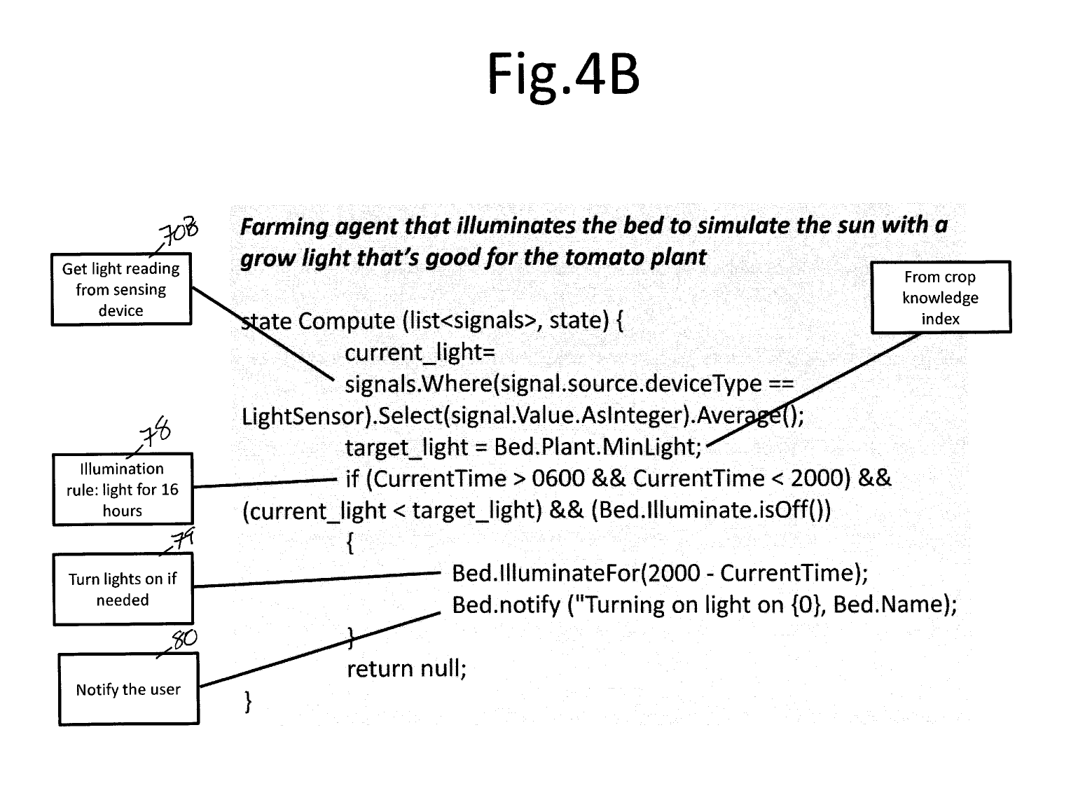

Reference is now made to FIGS. 4A and 4B, which provide sample code for two farming agents for a tomato plant grown in a bed which is monitored by two soil moisture sensors and watered by a water valve. FIG. 4A illustrates an irrigation agent, which may irrigate to achieve a desired soil moisture but not more than every 6 hours and FIG. 4B illustrates an illumination agent to illuminate the bed to simulate the sun with a grow light.

At item 70(A or B), each agent updates its measurement information from its associated sensor. This event driven line defines which sensor is the activating sensor for the farming agent. The reading event from the sensor includes routing/communication headers which may include deviceID, time stamp, message ID, hub ID, and a number 0 . . . 1023 which represents soil conductivity or light illumination.

Since the agent instance is coupled with a bed, the event triggers a compute cycle of agent code. In FIG. 4A, this code includes pulling (item 72) a target moisture level from crop knowledge index 58 and then checking if either the current moisture is too low or if it has been over 6 hours since the last irrigation, where the last irrigation time is store as an agent state (item 73) stored in field variable storage 56. If the check is true, then the agent provides an irrigation command (item 74) to the bed and a notification (item 76) to the farmer.

Although not shown in the simple agent instance of FIG. 4A, agent evaluation engine 42 may enforce user preferences and business rules, as stored in farm configuration section 59 of database 32, on the agent output. For example, it may continually calculate the amount of water in a bed and compare it to a maximum water capacity of the bed and to a predefined water budget.

The agent in FIG. 4B has an illumination rule (item 78) to illuminate during a 16 hour period and checks if the current illumination light is too low compared to a target light value, listed in crop knowledge index 58, during the defined period. If the check is true, then the agent provides an illumination command (item 79) to the bed and a notification (item 80) to the farmer.

Although not shown in the simple agent instances of FIGS. 4A and 4B, agent evaluation engine 42 may receive external environmental information, such as weather forecasts and crop infestation information in a nearby area or region of growing beds 20, and, if so indicated in the relevant farming agent 40, may incorporate this information when generating cultivation instructions and insights.

It will be appreciated that farming agents 40 are not straightforward garden controllers, but are garden ‘cultivation programs’. Standard controllers respond to the state of a single variable. Farming agents 40, on the other hand, respond to the state of multiple variables, some of which are measured external to the particular bed. Farming agents 40 enable a farmer to define complex logic, including business-based logic, to control and cultivate a bed or group of beds. User interface 60 may present the growing bed status to the farmer, may enable the user to define system settings and may present insights, instructions and reports. To set up a bed 20, a farmer may upload a photo of the bed, may tag plants in the photo and may connect the plants, sensors, actuators, locations, etc. to the associated farming agent(s) 40. User interface 60 may present recommendations to the farmer for farming agents and recommendations on how to take care of his plants. User interface 60 may also present the data from plant catalog 52, which may incorporate information on what plants needs in order to grow.

It will be appreciated that cultivation system 10 may convert the entire horticulture lifecycle to a digital one by programmatically controlling the environment in which plants grow. Cultivation system 10 may enable greater access for farmers to horticultural knowledge and may define a language for “programming” a garden, field or bed. In addition, it may enable the farmer to perform farming activities and related research through a unified interface and it may accommodate farming activities to changes in conditions based on real-time data coming from sensing devices and from the cloud (e.g. weather forecasts).

At the same time, cultivation system 10 may also create a farming community to share farming knowledge in many ways, via crop knowledge index 58 and growing recipes database 54. It will be appreciated that community plant knowledge, user feedback and insights gained from statistical reviews of crop knowledge index 58 may increase crop knowledge for all farmers using cultivation system 10 and may enable a relatively quick spread of farming ideas. In addition, per bed 20, cultivation system 10 may improve the quality and yield from each bed 20 by computing insights on individual plant status and by providing real-time recommendations to the farmer about how to grow each plant.

Referring back to FIG. 3, it will be appreciated that cultivation system 10 may provide a gardening platform with a device layer, comprising sensors 24 and 26, a device communication layer for sensors 24 and actuators 26, an operating layer for agent evaluation engine 42, a storage layer for databases 56, 58 and 59 and for user account and social media databases, and a user interface layer for user interface 60 and farming agent editor 50. The user interface layer may allow farmers to configure farming agents 40, manage connected devices, review and change settings and configuration, etc.

The device communication layer may be a proprietary protocol which may control the communication to and from sensors 24 and actuators 26. The communications may be in the form of messages to be sent “through the cloud” (i.e. on internet 70) with sensor state in them as well as instructions from the cloud to actuators 26. The communication must be sufficiently real-time for the agent evaluation layer to act on the information in the messages. One appropriate protocol may be a message exchange protocol which supports small, low-battery devices that work “offline” (i.e. which connect sporadically). The protocol also supports a spatially-unlimited number and type of devices, including low data devices and more data intensive devices, like cameras.

In one embodiment of cultivation system 10, the protocol may be implemented on a wireless sensor network for capturing field variables and communicating the data to the cloud. In very large fields and areas where there may be no connectivity between sensors, hub 28 may be mounted on a nearby UAV (unmanned aerial vehicle) or drone and may receive communicate directly with each sensor 24 and actuator 26. Such a hub 28 may not require any ACK/NACK acknowledgements, in order to reduce the amount of messages being transferred. Instead, system 10 may rely on lower levels of transmission for reliable transfer. Multiple messages may be transferred at one time in a single payload and timestamps may be managed by agdata endpoint 52, rather than by each device. This may enable system 10 to support a wide range of devices, which may or may not have good quality timers thereon.

In one embodiment of cultivation system 10, devices 24 and 26 may be connected in a tree topology. The tree size and structure may be limited only by physical characteristics, like bandwidth and weather. Alternatively, they may be connected in a star topology, with hub 28 as the center of the star, or in any other topology.

The requirements for the storage layer of garden I/O database 32 and its various elements are fast access to large amounts of measurement data and minimal use of relational storage to allow flexibility and secured storage for user's personal data. It may be implemented with finely-balanced relational and non-relational tables, such as may be implemented with the SQL and NoSQL database programs of Microsoft, USA. For example, measurements, signals, states and algorithms may be stored in the NoSQL databases to enable fast lookup of large datasets while the user account settings and farm/bed configurations may be stored in the SQL databases to support relational DB querying.

The user interface layer may support all user flows, including farm and bed setup and privacy settings (e.g. data usage). It may enable both user-level and system-level applications and may enable farmers to run applications to both view and interact with the state of the beds.

The user interface layer may be implemented with system atomic parts and may communicate with a “kernel” abstraction via HTTP using user-side calls. This may enable both a fast and responsive experience and may enable scalability.

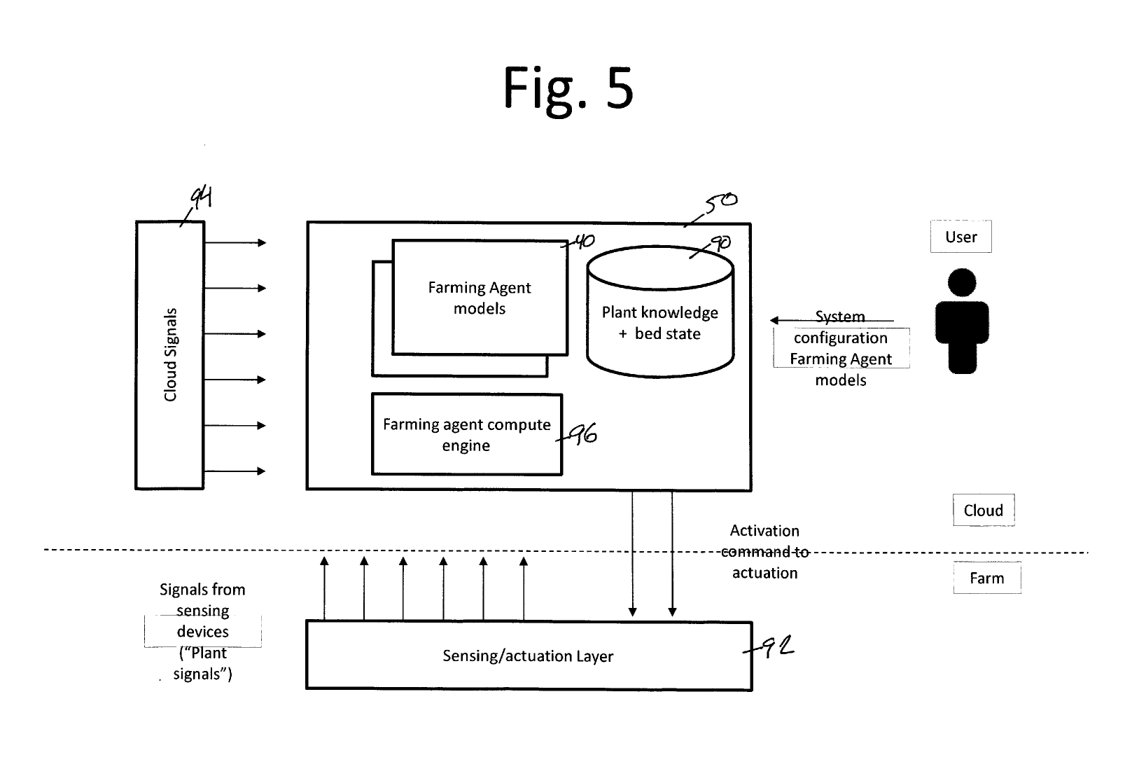

Reference is now made to FIG. 5, which provides another model of the operation of cultivation system 50. Cultivation system 10 may store a plurality of farming agent models 70, each configured by a farmer and defining an algorithm that outputs cultivation instructions required for a desired heath status of a plant.

Cultivation system 10 may store plant knowledge in an index 90, which may have a graph or index structure and may be similar to crop knowledge index 58. For example, plant knowledge graph may store attributes of plants, such as origin, required cultivation environment, growing constraints, companion plants, risk conditions, health/disease indicators, etc. Index 90 may also store plant health state and bed state, which may list the status of the plant conditions at a given point in time.

Cultivation system 10 may receive plant signals, which may be transmitted by probes and may monitor the conditions in which plants grow, such as pH, EC (electrical conductivity), light, temperature, growth medium, moisture, humidity, micro-climate etc., from device layer 92 as well as cloud signals 94 from other cloud services, such as a weather forecast, crop risk models, etc.

Cultivation system 10 may also comprise a farming agent compute engine 96, such as agent evaluation engine 42, to consume the plant and cloud signals and the previous plant health and bed states and to compute cultivation commands and recommendations for each farming agent model 40, as required.

In order to provide recommendations, farming agent compute engine 96 may comprise yield optimizer 44 and plant health analyzer 46. Yield optimizer 44 may periodically or irregularly compare ideal data in plant catalog 52 on the plants within a given bed with historical sensor measurements and may cross reference the data from the bed with other growing beds that have similar characteristics. Yield optimizer 44 may then generate personalized cultivation recommendations to said farmer. Yield optimizer 44 may also recommend which plants should be grown together based on companion planting know-how stored in plant knowledge index 90.

Plant health analyzer 46 may estimate plant health by capturing feedback from the farmer and from sensing devices and by comparing the feedback to information on plant growth in a similar or an ideal environment which is stored in plant knowledge index 90.

Plant health analyzer 46 may perform the following exemplary calculation for plant health, assuming a model of a plant cultivation lifecycle L as a time-ordered list of events e:

{e}:L=[e₀,e₁,e₂,e₃ . . . e_{N}] Equation 1

where events may be plant signals as well as images of the plant and farmer observations. Events may have pre-defined positive or negative aprioi weights w(e), where w(e)ε[−1,1]. For example, the weights w(e) may be based on values, provided by an SME (a subject matter expert, such as an agronomist). Negative weights may be given to changes in the environment of the plant (i.e. the plant signals) and the physical state of the plant may be given positive weights.

For example, the following series of signals of a plant may be received, at times Tj, where j=0-6:

T0: Seed planted (input received from the farmer)

T1: Full sun for 12 hours (input received from a sensor)

T2: irrigation started (plant state determined by the farming agent)

T3: irrigation stopped (plant state determined by the farming agent)

T4: Stem sprouted (input received from the farmer)

T5: irrigation started (plant state determined by the farming agent)

T6: irrigation stopped (plant state determined by the farming agent)

Events may also have individual “payouts” associated therewith, which may be determined by plant growth processes, as follows:

Payout(e)=time_to_next_event(e,L) Equation 2

Plant health analyzer 46 may compute plant health over time as a sum of the positive and negative contributions from the events, normalized by time.

$$PlantHealth ( L ) = \frac{{\sum }_{e ∈ L} w ( e ) * Log ( 1 + Payout ( e ) )}{{\sum }_{e ∈ L} 1 * Log ( 1 + Payout ( e ) )} \qquad Equation 3$$

PlantHealth(L) is a score indicating how the plant has successfully utilized its potential for growth.

As discussed hereinabove with respect to FIG. 1, cultivation system 10 may also provide access to plant knowledge to a community of farmers and researchers, through growing recipes database 54 and through crop knowledge index 58 (FIG. 3). Both may be updated by various users via user interface 60 or via an application programming interface (API) used by third party applications, such as those used by various social media applications.

The API may be any suitable API, such as a CRUD (Create, Read, Update, Delete) API via RESTful API and may open any system abstraction to third party applications. For example, beds, devices, plants, agents and recipes all may be available for access to third party applications. There may also be an API to receive insights and notifications from the system.

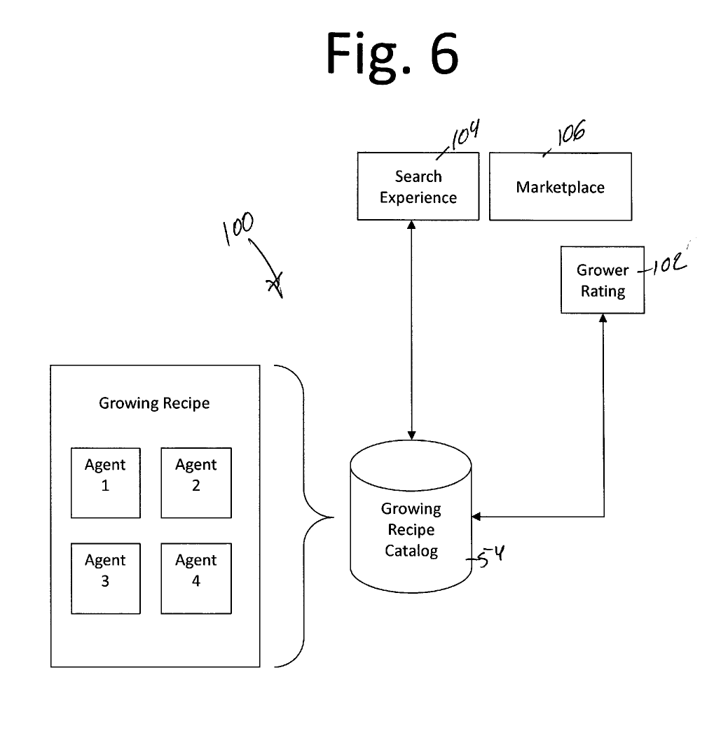

As discussed hereinabove, users of various kinds may utilize framing agent editor 50 to define growing recipes as a set of farming agents and may store their recipes in growing recipe database 54. These may be flagged as private or may be accessible to some or all other users. As shown in FIG. 6, to which reference is now briefly made, cultivation system 10 may comprise a growing recipe system 100 which may comprise growing recipe database 54, a recipe rating unit 102 and a recipe search unit 104. FIG. 6 shows an exemplary recipe that comprises four agents and is stored in growing recipe database 54. It will be appreciated that this is an example only; other recipes may comprise one or more agents.

Recipe rating unit 102 may generate ratings per recipe, based on community feedback or an external human judging process. Recipe search unit 104 may enable users to discover and apply recipes which match their crops, farm/garden setup, location, season and profile, etc.

In addition, cultivation system 10 may comprise a marketplace 106 through which users may share resources, collaborate, communicate and make transactions. Marketplace 106 may be similar to Amazon.com of the US (for buying equipment) or research companies for buying information and may be utilized to share and/or buy resources.

It will be appreciated that cultivation system 10 may have a number of key advantages. It may be flexible and may cover multiple growing scenarios: indoor and outdoor gardens, vertical gardens, hydroponics, aquaponics, open field, orchards or farms, and may cover various types of crops and plants. It may provide actuation and control for any type of growing solution. Any type of actuation, such as light, nutrient and irrigation, may be utilized, such that both indoor gardening and hydroponics may be supported.

Cultivation system 10 may be built as a software platform supported by dedicated high-tech hardware that can power 3^{rd} party products and experiences. For example, a home hydroponics appliance for growing leafy greens may be sensed and actuated by electronic devices and may be controlled through APIs to system 10.

It will be appreciated that cultivation system 10 is a hardware agnostic software platform which may integrate with any sensing and any activation device that is already in use in the field. Moreover, cultivation system 10 may be controlled from a UI layer or an API.

It will further be appreciated that cultivation system 10 may have a simple user interface for farmers, which may also be appropriate for other users, such as home garden users, DIY kits for kids, research farms, Cannabis, etc. It may be a very scalable platform, which may be usable for all kinds of gardens, from urban farms to small owner farms to broad acre industrial farming and may be used to define an unlimited number of growing beds, agents, and hardware devices.

It will further be appreciated that system 10 may be operated without sensors 22 and actuators 24. In this embodiment, the farmer may provide all of the input and may handle all of the cultivation. System 10 may provide cultivation insights based on whatever input the farmer may provide and based on the other information the system collects, as described hereinabove.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, it may comprise a general-purpose computer or a client/server set of computers selectively activated or reconfigured by a computer program stored in the computer or client/server computers. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose or client/server systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for managing cultivation of plants, the system comprising:
a database storing information about a plurality of growing beds; and
a multiplicity of farming agents, each associated with one growing bed, each farming agent to run a cultivation program on inputs from a farmer of said associated growing bed and information about said associated growing bed from said database, to enforce user preferences and business rules for said associated growing bed and to provide cultivation instructions to said farmer to cultivate its associated growing bed.

2. The system according to claim 1 and also comprising input from at least one of: a community of growers and from external sources.

3. The system according to claim 1 and also comprising at least one sensor to measure an attribute of at least one growing bed having said plants and at least one actuator to provide an input to said at least one growing bed.

4. The system according to claim 1 and wherein said database comprises a crop knowledge index to store cultivation parameters as a function of crop variety and cultivation method.

5. The system according to claim 1 and wherein said instructions to said farmer comprise at least one of: harvesting, manual irrigation, manual fertilizing, pest control, disease control, scouting, weeding, testing and pruning of said plants in said bed.

6. The system according to claim 1 and also comprising a yield optimizer to compare ideal plant data to historical data on said plants to generate personalized cultivation recommendations to said farmer.

7. The system according to claim 1 and also comprising a plant health analyzer to estimate health of said at least one plant by capturing feedback at least from the farmer and by comparing said feedback to information on plant growth in similar environment.

8. The system according to claim 1 and also comprising a wireless sensor network to connect said at least one sensor and said at least one actuator together and to communicate with a hub.

9. The system according to claim 8 and wherein said hub communicates with said multiplicity of farming agents via a data network.

10. The system according to claim 8 and wherein said hub is mounted on an aerial device.

11. The system according to claim 1 and also comprising an agent evaluation engine to activate an associated farming agent upon receipt at least of measurements from an associated sensor.

12. The system according to claim 1 and also comprising a growing recipe database to store farming agent growing recipes produced by a multiplicity of farmers.

13. The system according to claim 12 and also comprising a growing recipe rating unit to store ratings for said farming agent growing recipes.

14. The system according to claim 12 and also comprising a marketplace to enable said multiplicity of farmers to share resources for their growing beds.

15. The system according to claim 1 and wherein said at least one bed is at least a portion of: an indoor garden, an outdoor garden, a vertical garden, a hydroponic garden, an aquaponics garden, a field, an orchard and a farm.

16. The system according to claim 3 and wherein said at least one sensor senses one of: pH, soil moisture, light, temperature, electrical conductivity, nutrients and an image of the bed.

17. The system according to claim 3 and wherein said at least one actuator is one of: an illumination element, a nutrient provider, a watering system, an irrigation valve, an irrigation pump and a fertilizing element.

18. The system according to claim 2 and wherein said external sources are one of: a weather forecast and a crop infestation forecast.

19. A system for managing cultivation of plants, the system comprising:
a cultivation program to perform complex logic on inputs at least from one sensor and from a farmer about an associated growing bed and from external data at least about the region of said associated growing bed and to provide cultivation instructions to at least one actuator and to said farmer to cultivate said associated growing bed.

20. A method for managing cultivation of plants, the method comprising:
storing information about a plurality of growing beds in a database; and
running a cultivation program on inputs from a farmer of said associated growing bed and information about said associated growing bed from said database, the cultivation program to enforce user preferences and business rules for said associated growing bed and to provide cultivation instructions to said farmer to cultivate its associated growing bed.

21. The method according to claim 20 and also comprising input from at least one of: a community of growers and from external sources.

22. The method according to claim 20 and also comprising measuring an attribute of at least one growing bed having said plants and providing an input to said at least one growing bed.

23. The method according to claim 20 and also comprising storing cultivation parameters as a function of crop variety and cultivation method in said database.

24. The method according to claim 20 and wherein said instructions to said farmer comprise at least one of: harvesting, manual irrigation, manual fertilizing, pest control, disease control, scouting, weeding, testing and pruning of said plants in said bed.

25. The method according to claim 20 and also comprising comparing ideal plant data to historical data on said plants to generate personalized cultivation recommendations to said farmer.

26. The method according to claim 20 and also comprising estimating health of said at least one plant by capturing feedback at least from said farmer and by comparing said feedback to information on plant growth in similar environments.

27. The method according to claim 22 and also comprising connecting said at least one sensor and said at least one actuator together and communicating with a hub.

28. The method according to claim 27 and also comprising communicating with said multiplicity of farming agents via a data network.

29. The method according to claim 27 and also comprising mounting said hub on an aerial device.

30. The method according to claim 22 and also comprising activating said running upon receipt at least of measurements from an associated sensor.

31. The method according to claim 20 and also comprising storing growing recipes produced by a multiplicity of farmers.

32. The method according to claim 31 and also comprising storing ratings for said growing recipes.

33. The method according to claim 31 and also comprising enabling said multiplicity of farmers to share resources for their growing beds.

34. The method according to claim 20 and wherein said at least one bed is at least a portion of: an indoor garden, an outdoor garden, a vertical garden, a hydroponic garden, an aquaponics garden, a field, an orchard and a farm.

35. The method according to claim 22 and wherein said at least one sensor senses one of: pH, soil moisture, light, temperature, electrical conductivity, nutrients and an image of the bed.

36. The method according to claim 22 and wherein said at least one actuator is one of: an illumination element, a nutrient provider, a watering method, an irrigation valve, an irrigation pump and a fertilizing element.

37. The method according to claim 22 and wherein said external sources are one of: a weather forecast and a crop infestation forecast.
